(19) United States
(12) Patent Application Publication
(10) Pub. No.: US 2026/0168604 A1
(43) Pub. Date: Jun. 18, 2026

(54) QUICK-CONNECT DRIP IRRIGATION PIPE

(71) Applicant: YONGKANG LONGYINGFEI INDUSTRY AND TRADING CO., LTD., YongKang City (CN)

(72) Inventor: Feilong Lv, YongKang City (CN)

(21) Appl. No.: 19/533,771

(22) Filed: Feb. 9, 2026

(30) Foreign Application Priority Data
Jan. 19, 2026 (CN) 202620067447.9

(51) Int. Cl. F16L 37/084

(52) U.S. Cl. CPC F16L 37/0845

(57) ABSTRACT

A quick-connect drip irrigation pipe, comprising a flexible pipe body, a sheath, a connector, and an emitter; wherein the sheath is sleeved on the flexible pipe body, the emitter is embeddedly arranged along a pipe wall of the flexible pipe body, and the connector comprises a connecting pipe, a sleeve, and a clamping member; a connection head is provided at one end of the connecting pipe, and another end of the connecting pipe is sleeved and connected to the flexible pipe body; the sleeve is sleeved outside the sheath; the clamping member is composed of at least two clamping sleeves, and the at least two clamping sleeves press the sleeve through locking.

### TECHNICAL FIELD

The present invention relates to the technical field of drip irrigation tapes, and more particularly to a quick-connect drip irrigation pipe.

### BACKGROUND

A drip irrigation tape is an irrigation device that uses a low-pressure pipe system to directly convey water to a field, and then performs drip irrigation through an emitter installed on the pipe, such that water is dripped slowly and uniformly into soil near a root zone of a crop. A pipe thereof needs to be connected to other pipes or water supply equipment through a connector; however, the sealing performance of conventional connectors on the market is difficult to guarantee, which easily causes leakage at the end of the pipe. Meanwhile, the structure is complex and the connection operation is inconvenient. Therefore, a drip irrigation tape with a simple structure and fast and convenient connection is urgently needed.

### SUMMARY

The objective of the present invention is to provide a quick-connect drip irrigation pipe designed to solve the deficiencies of the above technologies.

The present invention designs a quick-connect drip irrigation pipe, comprising a flexible pipe body, a sheath, a connector, and an emitter; wherein the sheath is sleeved on the flexible pipe body, the emitter is embeddedly arranged along a pipe wall of the flexible pipe body, and the connector is connected to an end of the flexible pipe body; the connector comprising a connecting pipe, a sleeve, and a clamping member; wherein a connection head is provided at one end of the connecting pipe to connect external water supply equipment, and another end of the connecting pipe is sleeved and connected within the end of the flexible pipe body; the sleeve is sleeved outside the sheath located on the connecting pipe; the clamping member is composed of at least two clamping sleeves arranged around a circumferential direction of the sleeve, and the at least two clamping sleeves lock with each other to press the sleeve, thereby clamping the sheath and the flexible pipe body onto the connecting pipe.

Preferably, the sleeve is made of a flexible material; an annular groove is opened on an outer wall of a portion of the connecting pipe sleeved within the sleeve; a locking protrusion mating with the annular groove is provided on an inner wall of the clamping sleeve; and the locking protrusion presses the sleeve into the annular groove to increase sealing performance of a sleeved connection between the sleeve and the connecting pipe.

Further optimized, two locking protrusions are provided on the clamping sleeve, the two locking protrusions are arranged in parallel along a central axis, and a gap is left between the two locking protrusions.

Further optimized, when the clamping member is composed of two clamping sleeves, a partial groove is opened on each clamping sleeve; after the two clamping sleeves lock with each other, two partial grooves are spliced to form a perforation for the sleeve to pass through; one clamping sleeve is provided with through-holes at two sides of the partial groove, and another clamping sleeve is provided with studs, the studs being inserted into the through-holes to form an interference fit; or each clamping sleeve is provided with a through-hole and a stud at two sides of the partial groove respectively, and the stud of one clamping sleeve is inserted into the through-hole of another clamping sleeve to form an interference fit; or, when the clamping member is composed of three or more clamping sleeves, a partial groove is opened on each clamping sleeve; after every two adjacent clamping sleeves of the three or more clamping sleeves lock with each other, three or more partial grooves are spliced to form a perforation for the sleeve to pass through, and each clamping sleeve is provided with a through-hole and a stud at two sides of the partial groove respectively, such that the stud of one clamping sleeve of two adjacent clamping sleeves is inserted into the through-hole of another clamping sleeve of the two adjacent clamping sleeves to form an interference fit.

Further optimized, a threaded hole coaxial with the through-hole is opened on the stud, and the through-hole and the threaded hole are connected through a fastener.

Further optimized, each clamping sleeve is provided with a planar surface at a locking site; after the two clamping sleeves lock with each other, two opposite planar surfaces abut against each other, and the stud and the through-hole are arranged on the corresponding planar surfaces.

Further optimized, the sleeve extends outside the perforation at an end away from the connector to form a positioning end, and an anti-slip pattern is provided on an outer wall surface of the positioning end.

Preferably, the sheath is a braided layer.

Preferably, the emitter is a patch-type, and the emitter is embedded on an inner wall of the flexible pipe body; the emitter comprising a plate body, the plate body is provided with a labyrinth flow path, an inlet, and an outlet; the inlet and the outlet are respectively located at two ends of the labyrinth flow path, and both the inlet and the outlet communicate with the labyrinth flow path; the inlet further communicates with a lumen of the flexible pipe body, and a drip hole communicating with the inlet is opened on the pipe wall of the flexible pipe body.

Further optimized, the labyrinth flow path comprises a flow path body opened on the plate body, the flow path body extends along a longitudinal direction of the plate body; a plurality of protrusions are distributed at intervals along the longitudinal direction on two opposite side walls in the flow path body, and each protrusion of the two side walls in the flow path body is arranged in a staggered manner, thereby forming the flow path body in a zigzag shape.

The technical effects of the present invention are as follows: the pipe body of the drip irrigation pipe is a flexible pipe body, and the sheath is sleeved outside the pipe body, which both protects the pipe body to prevent damage and maintains the flexibility of the pipe body; an end of the pipe body is provided with a connector, the connector comprises a sleeve, a connecting pipe, and a clamping member; the connecting pipe and the sleeve are sleeved with each other, another end of the connecting pipe is provided with a connection head to connect external water supply equipment, and the pipe body and the sheath are simultaneously sleeved between the connecting pipe and the sleeve; the clamping member is formed by at least two clamping sleeves snapping with each other to clamp the sleeve, the pipe body, and the sheath onto the connecting pipe simultaneously, which increases the sealing performance of the connection between the end of the pipe body and the connector; the clamping sleeves mate with each other through the studs and the through-holes to form an interference fit, and then reinforce the connection through a fastener; specifically, one end of the connecting pipe is sealingly connected to the pipe body of the drip irrigation pipe through the clamping member and the sleeve, and another end of the connecting pipe is directly connected to external water supply equipment through the connection head; additionally, a butt-join can be formed between two pipe bodies through two connection heads, thereby forming a quick-connect drip irrigation pipe, which has a simple structure and is very convenient and rapid in assembly and disassembly.

### BRIEF DESCRIPTION OF THE DRAWINGS

FIG. 1 is a perspective view of an overall structure.

FIG. 2 is an exploded view of two clamping sleeves.

FIG. 3 is an exploded view of one type of connector.

FIG. 4 is an exploded view of another type of connector.

FIG. 5 is a sectional view of an emitter.

FIG. 6 is an exploded view of a clamping sleeve and a sleeve.

FIG. 7 is a connection schematic view of a sleeve, a flexible pipe body, a sheath, and a connecting pipe.

FIG. 8 is a structural schematic view between a flexible pipe body and a sheath.

FIG. 9 is an assembly schematic view between an emitter and a flexible pipe body.

FIG. 10 is an assembly schematic view between two clamping sleeves.

FIG. 11 is an assembly schematic view among three clamping sleeves.

### REFERENCE NUMERALS

1. flexible pipe body; 11. drip hole; 2. sheath; 3. connector; 31. connecting pipe; 311. annular groove; 32. sleeve; 321. positioning end; 322. anti-slip pattern; 33. clamping member; 331. clamping sleeve; 332. locking protrusion; 333. gap; 334. partial groove; 335. perforation; 336. through-hole; 337. stud; 338. threaded hole; 339. planar surface; 3310. fastener; 34. connection head; 341. external thread; 342. internal thread; 4. emitter; 41. plate body; 42. labyrinth flow path; 421. flow path body; 422. protrusion; 43. inlet; 431. grid window structure; 44. outlet.

### DETAILED DESCRIPTION OF THE DISCLOSURE

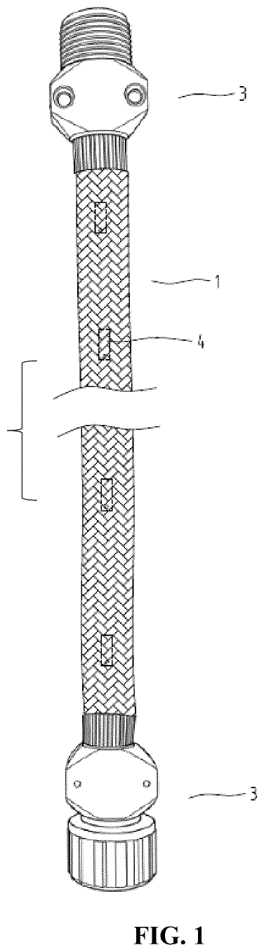

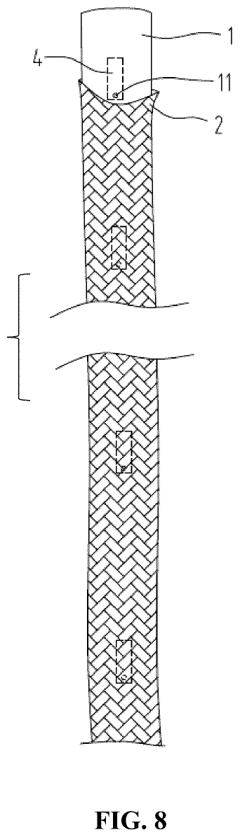

A quick-connect drip irrigation pipe of the present invention comprises a flexible pipe body 1, a sheath 2, a connector 3, and an emitter 4. As shown in FIG. 1 and FIG. 8, the sheath 2 is sleeved on the flexible pipe body 1. The sheath 2 is a braided layer. The sheath 2 protects the flexible pipe body 1 to avoid damage to the flexible pipe body 1 while maintaining flexibility of the flexible pipe body 1 and providing appropriate radial restriction to the flexible pipe body 1 to increase pressure resistance. The braided layer may be formed by weaving fiber strips made of nylon, rubber, polypropylene, or polyvinyl chloride.

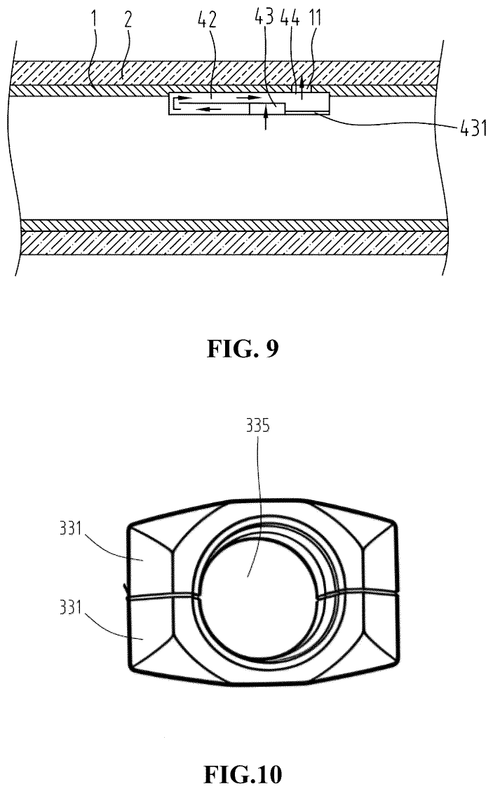

As shown in FIG. 1, a quantity of the connector 3 is set to two, and two connectors 3 are respectively connected to two ends of the flexible pipe body 1. The emitter 4 is embeddedly arranged along a pipe wall of the flexible pipe body 1. In this embodiment, a plurality of emitters 4 are distributed at intervals of a certain distance, and the plurality of emitters 4 are distributed along a straight line on the pipe wall of the flexible pipe body 1. In this embodiment, the emitter 4 is a patch-type, and the emitter 4 is attached to an inner wall of the flexible pipe body 1. As shown in FIG. 5 and FIG. 9, the emitter 4 comprises a rectangular plate body 41. The plate body 41 is made of a plastic material. A labyrinth flow path 42 is arranged along a longitudinal direction on the plate body 41. An inlet 43 and an outlet 44 are arranged at two ends of the labyrinth flow path 42. The labyrinth flow path 42 comprises a flow path body 421. The flow path body 421 is opened on the plate body 41 and extends along the longitudinal direction of the plate body 41. A plurality of protrusions 422 are distributed at intervals along the longitudinal direction on two opposite side walls in the flow path body 421. Each protrusion 422 of the two side walls in the flow path body 421 is arranged in a staggered manner, thereby forming the zigzag labyrinth flow path 42. The labyrinth flow path 42 may be a linear type, that is, extending from one end of the plate body 41 to another end. The flow path body 421 may also be a bent type, that is, extending from one end of the plate body 41 to another end and then being bent to return to a starting end, thereby forming two sections of the flow path body 421 parallel to each other, i.e., forming a bent labyrinth flow path 42. The inlet 43 and the outlet 44 are respectively located at two ends of the flow path body 421. Both the inlet 43 and the outlet 44 communicate with the flow path body 421. The inlet 43 further communicates with a lumen of the flexible pipe body 1. A drip hole 11 communicating with the inlet 43 is opened on the pipe wall of the flexible pipe body 1. Each of the inlet 43 and the outlet 44 is a groove structure opened on the plate body 41. Since the plate body 41 is attached to the inner wall of the flexible pipe body 1, the inner wall of the flexible pipe body 1 seals an opening of the outlet 44. The drip hole 11 is opened on the inner wall of the flexible pipe body 1 at the outlet 44, so that water from the outlet 44 comes out from the drip hole 11 to achieve a purpose of drip irrigation. A grid window structure 431 is formed at an opening of the inlet 43 to facilitate filtering water coming out from the flexible pipe body 1 and simultaneously slow down a flow rate of water flow entering the inlet 43. Water in the flexible pipe body 1 passes through the inlet 43 and then enters the labyrinth flow path 42, reaches the outlet 44 after passing through the labyrinth flow path 42, then is discharged to an outside of the flexible pipe body 1 from the outlet 44 through the drip hole 11, and finally seeps out from the sheath 2.

The sheath 2 not only protects the flexible pipe body 1 to avoid damage to the flexible pipe body 1 and maintains the flexibility of the flexible pipe body 1, but also avoids soil from clogging the emitter 4.

The connector 3 comprises a connecting pipe 31, a sleeve 32, and a clamping member 33. A connection head 34 for connecting external water supply equipment is arranged at one end of the connecting pipe 31. The connection head 34 may adopt different types of connection structures on the market to facilitate butt-joining to various faucets, pipelines, pipes, or adapters, etc., or two connection heads 34 form a butt-joint. Another end of the connecting pipe 31 is sleeved within the sleeve 32. As shown in FIG. 7, ends of the flexible pipe body 1 together with the sheath 2 are sleeved between the sleeve 32 and the connecting pipe 31. The clamping member 33 is arranged on an outer wall of the sleeve 32. The clamping member 33 is composed of at least two clamping sleeves 331 locking with each other. The at least two clamping sleeves 331 are arranged around a circumferential direction of the sleeve 32. After the two clamping sleeves 331 lock with each other, the sleeve 32 is pressed, and subsequently, the sheath 2 and the flexible pipe body 1 are pressed, thereby clamping the sheath 2 and the flexible pipe body 1 onto the connecting pipe 31.

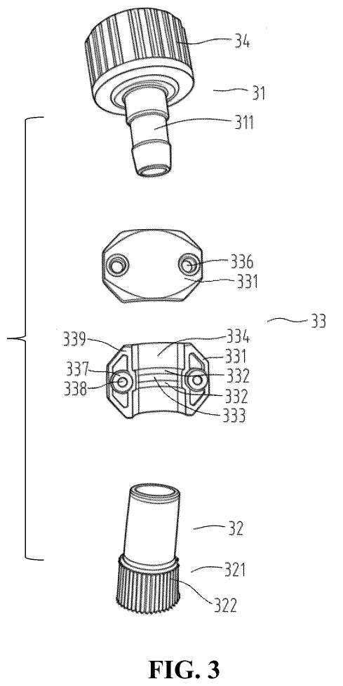

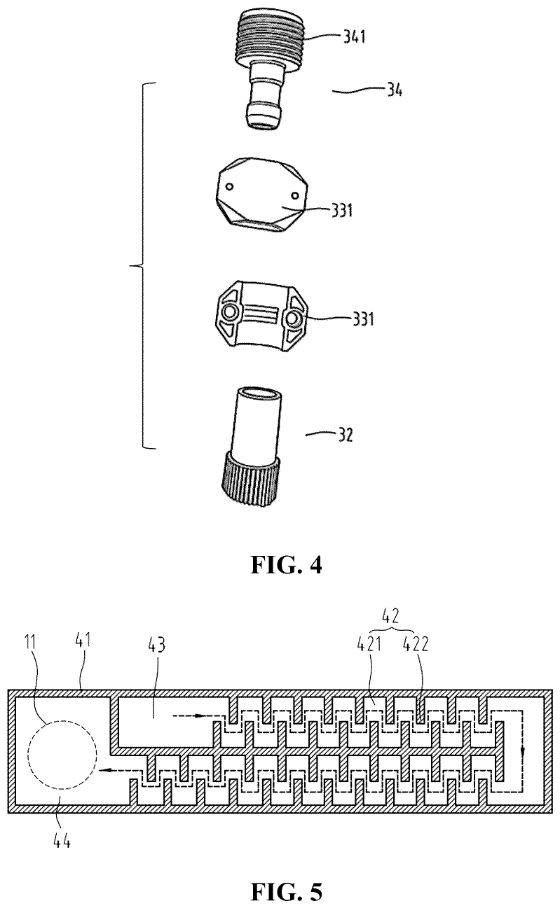

In this embodiment, as shown in FIG. 3, the connection head 34 of one connector 3 is provided with an external thread 341. As shown in FIG. 4, the connection head 34 of another connector 3 is provided with an internal thread 342. The two connection heads 34 form a connection through cooperation of the internal thread 342 and the external thread 341, such that the two connectors 3 form a butt-joint, which can achieve a connection between two drip irrigation pipes.

Further, the sleeve 32 is made of a flexible material, such as rubber, soft plastic, etc. An annular groove 311 is opened on an outer wall of a portion of the connecting pipe 31 sleeved within the sleeve 32. A locking protrusion 332 mating with the annular groove 311 is provided on an inner wall of the clamping sleeve 331. After the connecting pipe 31 is sleeved within the sleeve 32, the locking protrusion 332 presses the sleeve 32 into the annular groove 311. The sheath 2 is sleeved between the connecting pipe 31 and the sleeve 32. The locking protrusion 332 is similar to a clamping ring structure to clamp the sleeve 32, the sheath 2, and the flexible pipe body 1 onto the connecting pipe 31. This not only secures a connection among the sleeve 32, the sheath 2, the flexible pipe body 1, and the connecting pipe 31, but also increases sealing performance of a sleeved connection between the flexible pipe body 1 and the connecting pipe 31.

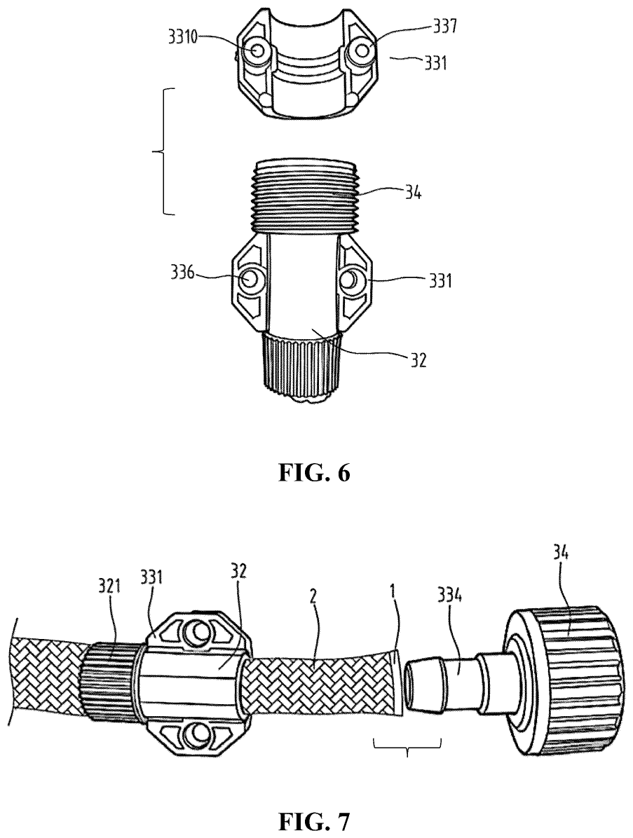

Further, as shown in FIG. 6, two locking protrusions 332 are arranged on each clamping sleeve 331. The two locking protrusions 332 are arranged in parallel along an axial direction of a central axis of the clamping member 33, and a gap 333 is left between the two locking protrusions 332. The two locking protrusions 332 together press the sleeve 32 and the sheath 2 into the annular groove 311. When the two locking protrusions 332 squeeze the sleeve 32 and the sheath 2 together, the gap 333 can accommodate a deformed portion of the sleeve 32 and the sheath 2 generated by squeezing, making a clamped connection more stable.

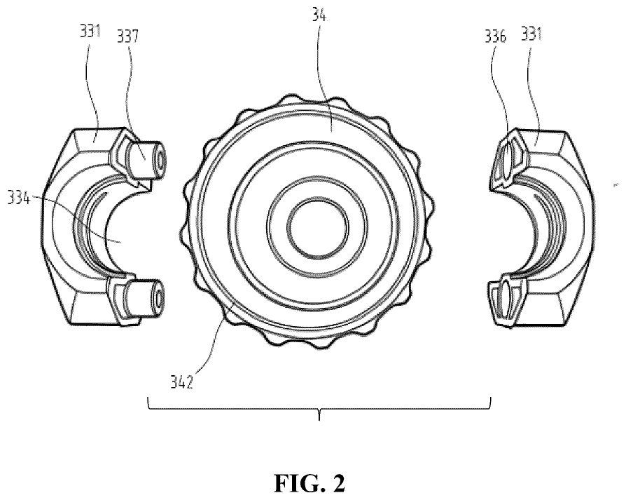

Further, in this embodiment, as shown in FIG. 2, each clamping member 33 is composed of two clamping sleeves 331. A partial groove 334 is opened on each clamping sleeve 331, and the locking protrusion 332 is located within the partial groove 334. As shown in FIG. 10, after the two clamping sleeves 331 lock with each other, two partial grooves 334 are spliced to form a perforation 335 for the sleeve 32 to pass through. The locking protrusions 332 on the two clamping sleeves 331 are also spliced to form an annular locking protrusion 332. One clamping sleeve 331 is provided with through-holes 336 at two sides of the partial groove 334, and another clamping sleeve 331 is provided with studs 337 inserted into the through-holes 336 to form an interference fit; or each clamping sleeve 331 is provided with a through-hole 336 and a stud 337 at two sides of the partial groove 334 respectively, such that the stud 337 of one clamping sleeve 331 is inserted into the through-hole 336 of another clamping sleeve 331 to form an interference fit. The clamping member 33 realizes clamping the sleeve 32 and the sheath 2 onto the connecting pipe 31 through fixed connection between the two clamping sleeves 331.

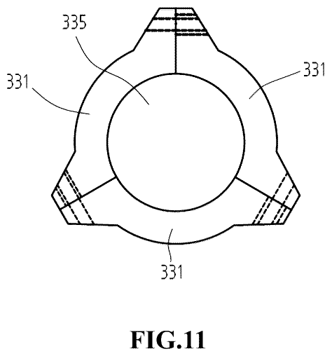

In another embodiment, as shown in FIG. 11, the clamping member 33 is composed of three or more clamping sleeves 331. A partial groove 334 is opened on each clamping sleeve 331, and a locking protrusion 332 is arranged in each partial groove 334. After the three or more clamping sleeves 331 are distributed along an outer circumferential direction of the sleeve 32 and every two adjacent clamping sleeves 331 lock with each other, three or more partial grooves 334 are spliced to form a perforation 335 for the sleeve 32 to pass through. Each clamping sleeve 331 is provided with a through-hole 336 and a stud 337 at two sides of the partial groove 334 respectively, such that the stud 337 of one clamping sleeve 331 of two adjacent clamping sleeves 331 is inserted into the through-hole 336 of another clamping sleeve 331 to form an interference fit.

Further, a threaded hole 338 coaxial with the through-hole 336 is opened on the stud 337. The through-hole 336 and the threaded hole 338 are connected through a fastener 3310 such as a bolt or a screw, achieving detachable connection between the clamping sleeves 331.

Further, each clamping sleeve 331 is provided with a planar surface 339 at a locking site. The stud 337 and the through-hole 336 are arranged on the corresponding planar surface 339. After the two clamping sleeves 331 lock with each other, two opposite planar surfaces 339 abut against each other, and meanwhile, the interference fit is formed between the corresponding stud 337 and the through-hole 336 on the two planar surfaces 339. The two opposite planar surfaces 339 abut against each other, which increases a contact area of the two clamping sleeves 331 and strengthens stability of the two clamping sleeves 331 after locking with each other.

Further, the sleeve 32 extends outside the perforation 335 at an end away from the connector 3 to form a positioning end 321. The positioning end 321 has a cylindrical shape. The sheath 2 and the flexible pipe body 1 enter into the sleeve 32 after passing through the positioning end 321. An anti-slip pattern 322 is provided on an outer wall surface of the positioning end 321 to facilitate manually operating the sleeve 32 for sleeving.

What is claimed is:

1. A quick-connect drip irrigation pipe, comprising a flexible pipe body, a sheath, a connector, and an emitter; wherein the sheath is sleeved on the flexible pipe body, the emitter is embeddedly arranged along a pipe wall of the flexible pipe body, and the connector is connected to an end of the flexible pipe body;
the connector comprising a connecting pipe, a sleeve, and a clamping member; wherein a connection head is provided at one end of the connecting pipe to connect external water supply equipment, and another end of the connecting pipe is sleeved and connected within the end of the flexible pipe body; the sleeve is sleeved outside the sheath located on the connecting pipe; the clamping member is composed of at least two clamping sleeves arranged around a circumferential direction of the sleeve, and the at least two clamping sleeves lock with each other to press the sleeve, thereby clamping the sheath and the flexible pipe body onto the connecting pipe.

2. The quick-connect drip irrigation pipe according to claim 1, wherein the sleeve is made of a flexible material; an annular groove is opened on an outer wall of a portion of the connecting pipe sleeved within the sleeve; a locking protrusion mating with the annular groove is provided on an inner wall of the clamping sleeve; and the locking protrusion presses the sleeve into the annular groove to increase sealing performance of a sleeved connection between the sleeve and the connecting pipe.

3. The quick-connect drip irrigation pipe according to claim 2, wherein two locking protrusions are provided on the clamping sleeve, the two locking protrusions are arranged in parallel along a central axis, and a gap is left between the two locking protrusions.

4. The quick-connect drip irrigation pipe according to claim 3, wherein a partial groove is opened on each clamping sleeve when the clamping member is composed of two clamping sleeves, and after the two clamping sleeves lock with each other, two partial grooves are spliced to form a perforation for the sleeve to pass through; one clamping sleeve is provided with through-holes at two sides of the partial groove, and another clamping sleeve is provided with studs, the studs being inserted into the through-holes to form an interference fit; or each clamping sleeve is provided with a through-hole and a stud at two sides of the partial groove respectively, and the stud of one clamping sleeve is inserted into the through-hole of another clamping sleeve to form an interference fit; or, when the clamping member is composed of three or more clamping sleeves, a partial groove is opened on each clamping sleeve, and after every two adjacent clamping sleeves of the three or more clamping sleeves lock with each other, three or more partial grooves are spliced to form a perforation for the sleeve to pass through, and each clamping sleeve is provided with a through-hole and a stud at two sides of the partial groove respectively, such that the stud of one clamping sleeve of two adjacent clamping sleeves is inserted into the through-hole of another clamping sleeve of the two adjacent clamping sleeves to form an interference fit.

5. The quick-connect drip irrigation pipe according to claim 4, wherein a threaded hole coaxial with the through-hole is opened on the stud, and the through-hole and the threaded hole are connected through a fastener.

6. The quick-connect drip irrigation pipe according to claim 5, wherein each clamping sleeve is provided with a planar surface at a locking site; after the two clamping sleeves lock with each other, two opposite planar surfaces abut against each other, and the stud and the through-hole are arranged on the corresponding planar surfaces.

7. The quick-connect drip irrigation pipe according to claim 4, wherein the sleeve extends outside the perforation at an end away from the connector to form a positioning end, and an anti-slip pattern is provided on an outer wall surface of the positioning end.

8. The quick-connect drip irrigation pipe according to claim 1, wherein the sheath is a braided layer.

9. The quick-connect drip irrigation pipe according to claim 1, wherein the emitter is a patch-type, the emitter is embedded on an inner wall of the flexible pipe body; the emitter comprising a plate body, the plate body is provided with a labyrinth flow path, an inlet, and an outlet; the inlet and the outlet are respectively located at two ends of the labyrinth flow path, and both the inlet and the outlet communicate with the labyrinth flow path; the inlet further communicates with a lumen of the flexible pipe body, and a drip hole communicating with the inlet is opened on the pipe wall of the flexible pipe body.

10. The quick-connect drip irrigation pipe according to claim 9, wherein the labyrinth flow path comprises a flow path body opened on the plate body, the flow path body extends along a longitudinal direction of the plate body; a plurality of protrusions are distributed at intervals along the longitudinal direction on two opposite side walls in the flow path body, and each protrusion of the two side walls in the flow path body is arranged in a staggered manner, thereby forming the flow path body in a zigzag shape.
